(19) United States
(12) Patent Application Publication
(10) Pub. No.: US 2015/0315044 A1
(43) Pub. Date: Nov. 5, 2015

(54) Apparatus for metallic particles separation

(71) Applicant: Kuan Ming Chen, Kaohsiung (TW)

(72) Inventor: Kuan Ming Chen, Kaohsiung (TW)

(21) Appl. No.: 14/795,893

(22) Filed: Jul. 10, 2015

(51) Int. Cl. C02F 1/461

(52) U.S. Cl. CPC C02F 1/46104; C02F 2101/203

(57) ABSTRACT

An apparatus for separating metallic particles from cooling water includes a housing including a body made of titanium wire mesh, and first and second side walls; and an electrode assembly disposed on a top of the housing to define a space in the housing. The electrode assembly includes cathodes electrically connected to the housing, and an anode in the space, the anode having a conductive assembly.

### BACKGROUND OF THE INVENTION

1. Field of the Invention

The invention relates to fouling removal and more particularly to an apparatus for separating metallic particles from cooling water circulating in a cooling water system.

2. Description of Related Art

It has been known that rust iron and inorganic salts may foul water systems and lead to very significant water system inefficiencies. These inefficiencies result in increased energy consumption and increased maintenance demands which, in turn, increase overall operational and maintenance costs by several orders of magnitude.

A conventional apparatus for generating ions within a water system comprises a water tank including a cylindrical tank interior, the tank interior including upper and lower tank portions, and the water tank further including a tank aperture at the upper tank portion whereby the tank interior is made accessible through the aperture and a side wall, a water inlet assembly, a water outlet assembly, and an ion generator including at least one anode and at least one cathode. Ions are generated.

While the device enjoys its success in the market, continuing improvements in the exploitation of apparatus for removing fouling are constantly sought.

### SUMMARY OF THE INVENTION

It is therefore one object of the invention to provide an apparatus for separating metallic particles from cooling water, comprising a housing including a body and a plurality of side walls; and an electrode assembly disposed on a top of the housing to define a space in the housing; wherein the electrode assembly includes cathodes electrically connected to the housing, and an anode in the space, the anode having a conductive assembly.

The above and other objects, features and advantages of the invention will become apparent from the following detailed description taken with the accompanying drawings.

### BRIEF DESCRIPTION OF THE DRAWINGS

FIG. 1 is a perspective view of an apparatus for metallic particles separation according to the invention and associated power supply and electric wire;

FIG. 2 is an exploded view of the apparatus;

FIG. 3 is another exploded view of the apparatus;

FIG. 4 is a perspective view of the housing;

FIG. 5A is a perspective view of the first side wall;

FIG. 5B is a perspective view of the body;

FIG. 5C is a perspective view of the second side wall;

FIG. 6 is a longitudinal sectional view of the apparatus showing a vibration thereof in the cooling water;

FIG. 7 is a perspective view showing the apparatus submerged in the cooling water; and

FIG. 8 is a top view schematically depicting metallic particles being separated from the cooling water and adhered to the housing.

### DETAILED DESCRIPTION OF THE INVENTION

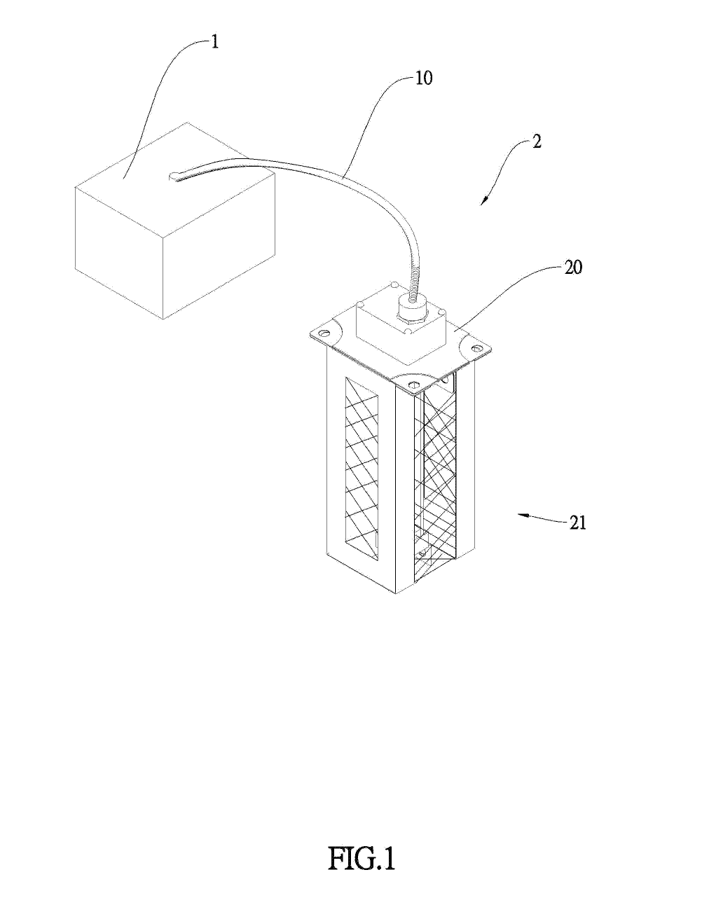

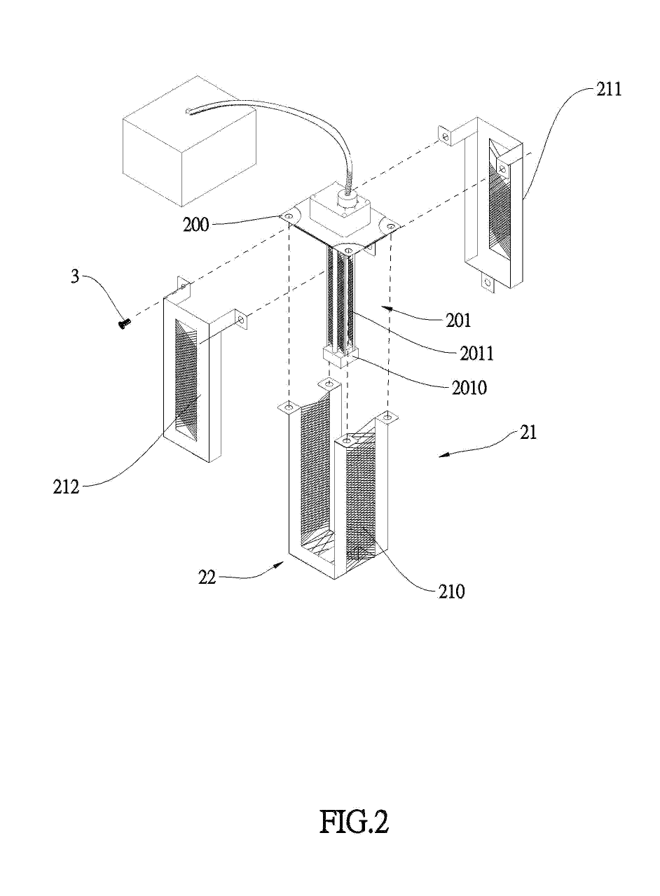

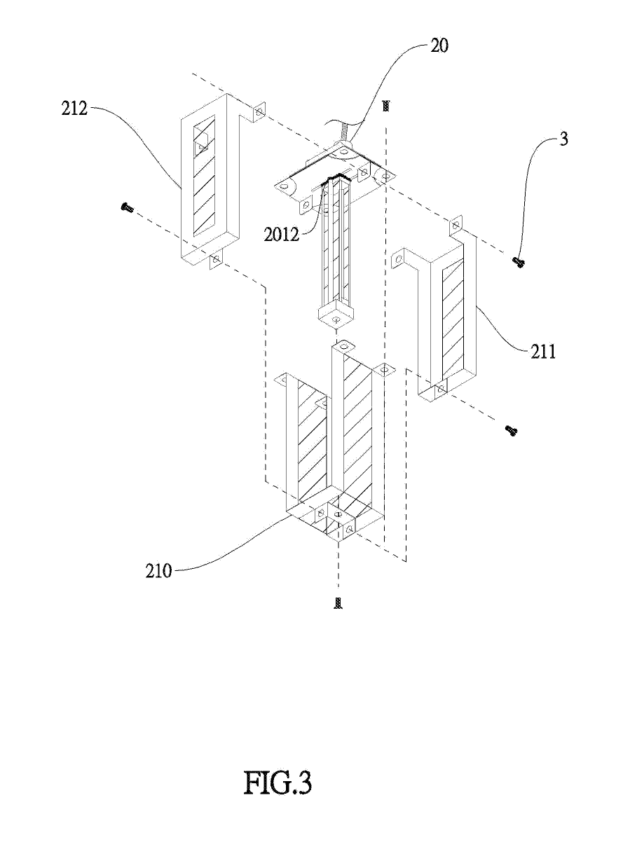

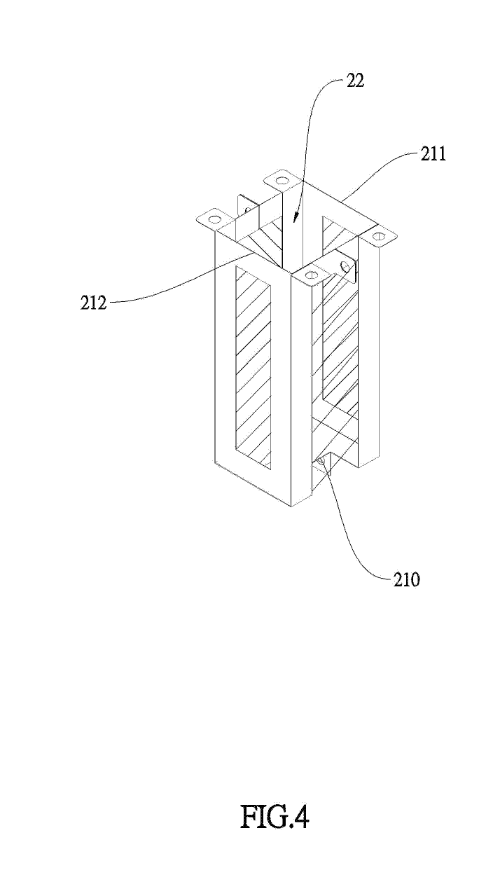

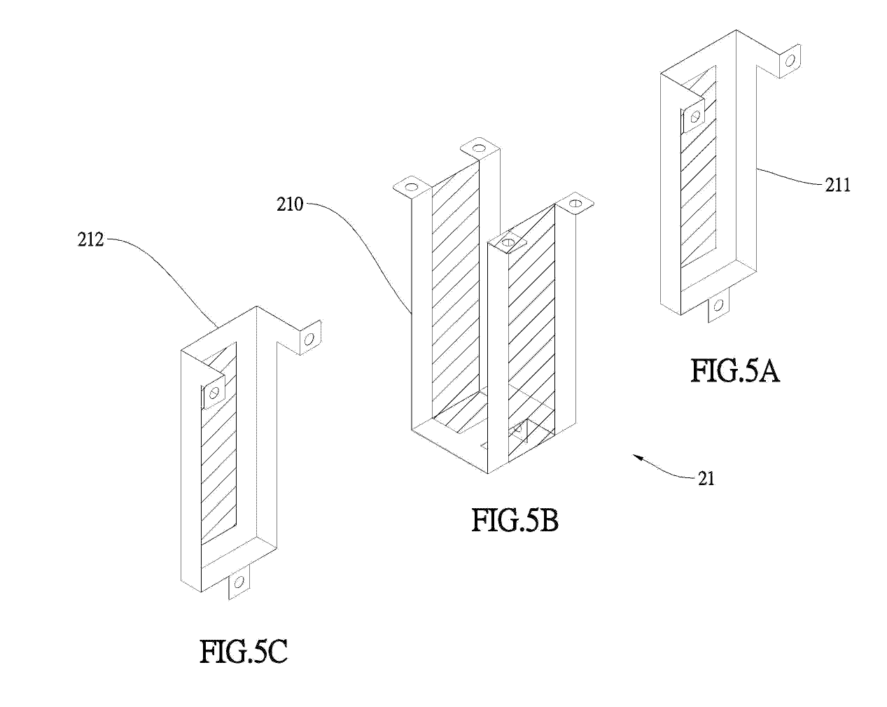

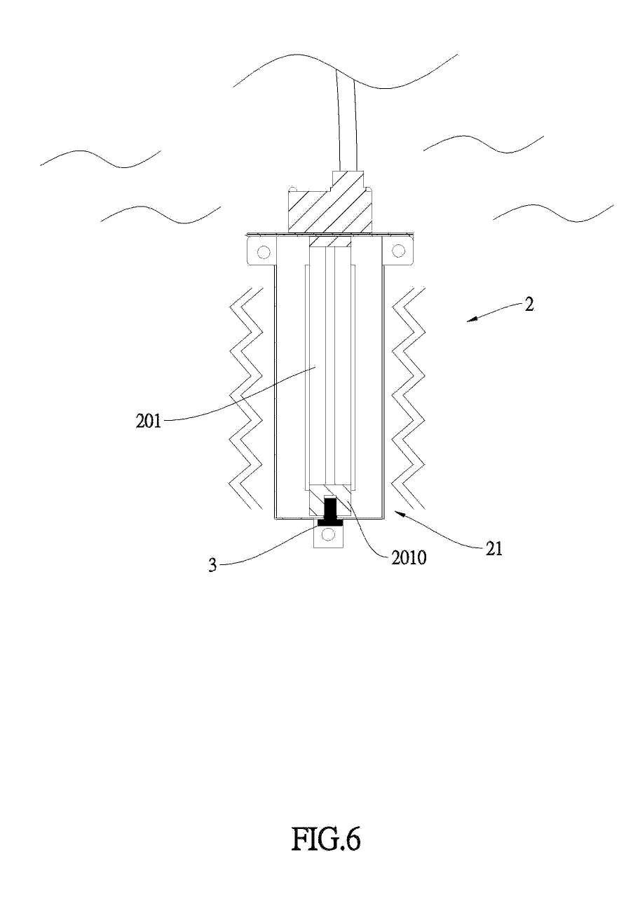

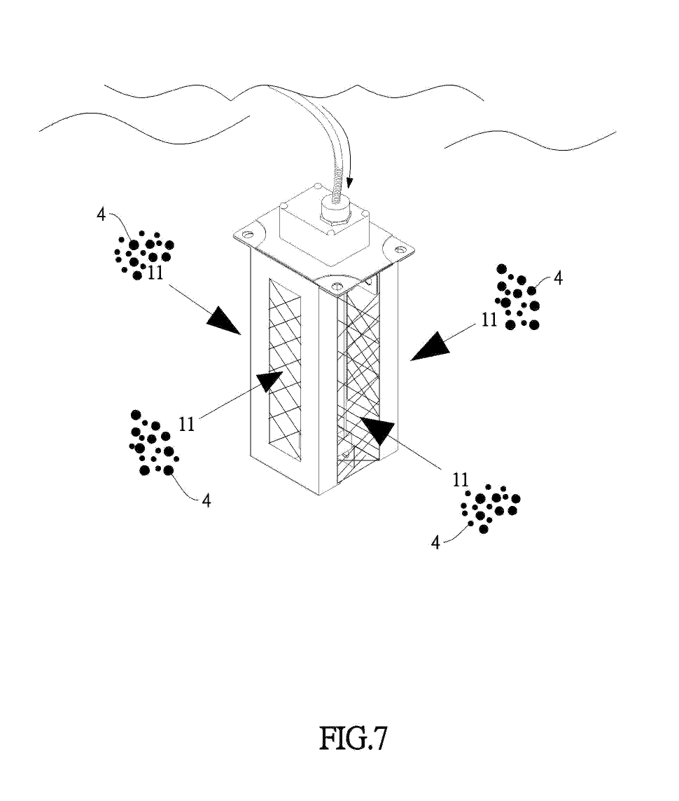

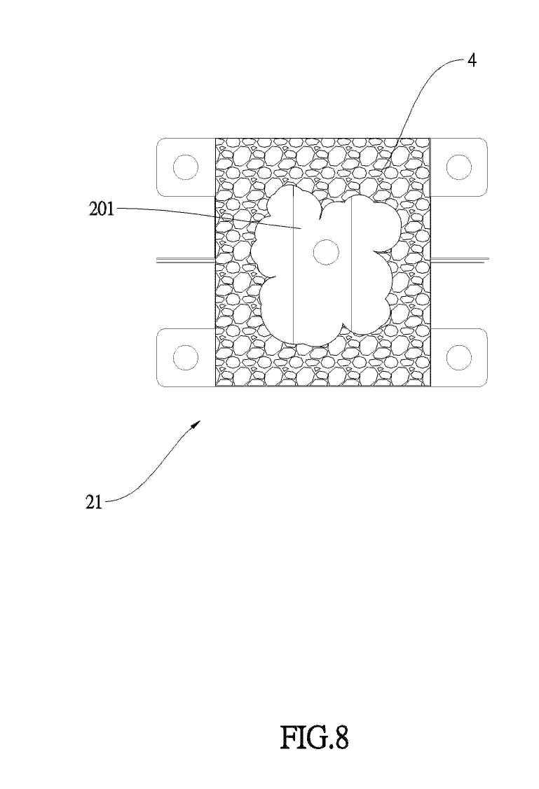

Referring to FIGS. 1 to 8, an apparatus 2 for metallic particles separation in accordance with the invention is shown. The apparatus 2 is powered by a direct current (DC) power supply (e.g., rechargeable battery) 1 via an electric wire 10. The apparatus 2 comprises the following components as discussed in detail below.

An electrode assembly 20 is provided on a housing 21 made of conductive metal (e.g., titanium) wire mesh. The housing 21 includes a U-shaped body 210, a first side wall 211, and a second side wall 212. A plurality of threaded fasteners 3 are used to fasten the electrode assembly 20, the body 210, and the first and second side walls 211, 212 together. A space 22 is formed by the assembled body 210 and the first and second side walls 211, 212. The electrode assembly 20 includes a plurality of cathodes 200 on a top, and an anode 201 having a base 2010 secured to a bottom of the body 210 by a threaded fastener 3, and upright conductors 211 interconnecting the base 2010 and the cathodes 200. A joining portion of the electrode assembly 20 and the anode 201 is applied with a waterproof adhesive 2012 so that the electrode assembly 20 is made waterproof.

Electrolysis is performed by the apparatus 2 as detailed below. The housing 21 is negative. Water (as solvent) recycles through a cooling water system. The apparatus 2 is immersed in the water. DC 11 is supplied from the DC power supply 1 to the cathodes 200 (i.e., an electrical potential applied across the anode 201 and the cathodes 200). Mobile positive and negative ions are produced by reaction of ionic compounds (e.g., rust iron) 4 with the water. Positively charged ions (i.e., cations) move towards the negative housing 21 (which is electrically connected to the cathodes 200) and negatively charged ions (i.e., anions) move towards the anode 201. As such, metallic substance of the ionic compounds 4 is formed on the housing 21 as fouling. Oxidation of ions occurs at the anode 201 and reduction of ions occurs at the negative housing 21. As a result, metallic particles, as source of forming fouling, are separated from the water. Therefore, the purpose of preventing fouling from being formed on an inner surface of a pipe in a piping system is achieved.

Further, cleaning of the housing 21 is made easy after disassembling the housing 21.

While the invention has been described in terms of preferred embodiments, those skilled in the art will recognize that the invention can be practiced with modifications within the spirit and scope of the appended claims.

What is claimed is:

1. An apparatus for separating metallic particles from cooling water, comprising:
a housing including a body and a plurality of side walls; and
an electrode assembly disposed on a top of the housing to define a space in the housing;
wherein the electrode assembly includes a plurality of cathodes electrically connected to the housing, and an anode in the space, the anode having a conductive assembly.

2. The apparatus for removing fouling of claim 1, wherein the side walls include a first side wall and a second side wall.

3. The apparatus for removing fouling of claim 1, wherein the housing is made of titanium wire mesh.

4. The apparatus for removing fouling of claim 1, wherein the electrode assembly is waterproof.

5. The apparatus for removing fouling of claim 1, wherein the electrode assembly is releasably disposed on the top of the housing.

6. The apparatus for removing fouling of claim 1, wherein the anode is configured to output DC.

7. The apparatus for removing fouling of claim 1, further comprising a base secured to both the conductive assembly and a bottom of the housing.

8. The apparatus for removing fouling of claim 1, wherein the anode and the conductive assembly are spaced.

9. The apparatus for removing fouling of claim 1, wherein the conductive assembly includes a plurality of conductors.
